(19) United States
(12) Patent Application Publication
(10) Pub. No.: US 2021/0001733 A1
(43) Pub. Date: Jan. 7, 2021

(54) DEVICE FOR GENERATING A MAGNETIC FIELD, IN PARTICULAR FOR AN INDUCTIVE CHARGING SYSTEM, AND PRIMARY DEVICE OF AN INDUCTIVE CHARGING SYSTEM FOR DYNAMICALLY CHARGING VEHICLES

(71) Applicant: INDUSTRIEANLAGEN-BETRIEBSGESELLSCHAFT MBH, Ottobrunn (DE)

(72) Inventors: Jürgen MEINS, Braunschweig (DE); Ralf EFFENBERGER, Brietlingen (DE)

(21) Appl. No.: 16/971,527

(22) PCT Filed: Feb. 23, 2018
(86) PCT No.: PCT/EP2018/054569

§ 371 Date: Aug. 20, 2020

(51) Int. Cl. B60L 53/122; B60L 53/65; B60L 53/66; B60L 53/39; H02J 7/00; H02J 7/04; H02J 50/12; H02J 50/80

(52) U.S. Cl. CPC B60L 53/122; B60L 53/65; B60L 53/66; B60L 53/39; H02J 2207/20; H02J 7/04; H02J 50/12; H02J 50/80; H02J 7/00032

(57) ABSTRACT

The invention relates to a device for generating a magnetic field, in particular for a primary apparatus of an inductive charging system, as well as to a primary apparatus of an inductive charging system for the contactless, inductive power transfer to transport means. With the objective of continually generating a magnetic field along a specific traveling direction, the device is provided with at least one electrical conductor for generating the magnetic field, a supply unit for generating an alternating current for the at least one electrical conductor, and a detection unit for detecting a secondary charging system. This device is characterized by a communication unit for transmitting and receiving data to/from an identical device, wherein the device is designed to control the signal control unit by means of the detection unit and/or by means of the received data, and hence the generation of the magnetic field for inductive power transfer. With respect to the primary apparatus, the latter has a plurality of interconnected devices for generating a magnetic field, wherein the devices have a plurality of electrical conductors for generating a magnetic field. In addition, the arrangement and actuation of electrical conductors of the devices are designed in such a way that a predetermined magnetic field can be generated by a portion of the electrical conductors, and this magnetic field can be displaced by correspondingly actuating the electrical conductors with a static motion.

The invention relates to a device for generating a magnetic field, in particular for an inductive charging system, as well as to a primary apparatus of an inductive charging system for the contactless, inductive power transfer to transport means.

To be understood in the following by the term “transport means” are vehicles driven by a separate motor, such as automobiles, motorcycles, and tractors. These types of vehicles can be mounted on rails or not mounted on rails. The motor itself can comprise a combustion engine, an electric motor, or a combination of the two.

Understood by the term “inductive charging system” is a system for power transfer via magnetic alternating fields. For this purpose, the system has a primary part or apparatus (also referred to as primary (charging) system) as the energy source and a secondary part or apparatus (also referred to as secondary (charging) system) as the energy receiver; similarly to a transformer. The primary apparatus is set up to generate a magnetic alternating field, and the secondary apparatus is set up to receive the magnetic alternating field and generate or derive an induction current from the magnetic alternating field. The magnetic alternating field is generated by electrical conductors carrying an alternating current, in particular coils, and the induction current is generated by electrical conductors positioned in the magnetic field.

As electric mobility continues to develop, alternatives to transport means driven by fossil fuels are being provided, which are already known today, for example in the form of hybrid and electric vehicles. However, the disadvantage to electric vehicles by comparison to gasoline-powered vehicles is that current power accumulators have a lower energy density relative to liquid fuels. The energy density of a lithium-ion battery measures 150 or 200 Wh per kg, which is significantly lower than gasoline at 12,800 Wh per kg. Therefore, it is virtually impossible for an electric vehicle to achieve the same transport range as a gasoline-powered vehicle. Even additional batteries are unable to offset the disadvantage since the additional weight of the batteries in turn causes the energy demand of the electric motor to rise.

By comparison to motor vehicles with combustion engines, an electric vehicle must thus frequently be charged given the same routes. To this end, there are various options for charging electric vehicles, such as battery changing stations, charging stations (also referred to as electric filling stations and charging posts) and inductive charging.

Instead of power transfer via cables and plug connectors, inductive charging uses magnetic alternating fields to inductively transmit energy from a primary side to a secondary side (vehicle side). Apart from avoiding plug connections on electrically conductive contacts subject to wear and tear, this also provides touch protection. In principle, use is here made of transformer technology with a primary-side excitation coil, which carries alternating current from the power supply. The alternating current coupled out in the vehicle-side induction coil converts the charging device built into the vehicle into direct current, and charges the battery inside the vehicle or supplies the drive.

This charging process can take place in a stationary manner, i.e., when the vehicle is not in motion or parked. The primary coil and secondary coil can here be positioned relative to each other in such a way as to provide optimal power transfer to the vehicle with low losses. However, stopping the vehicle does entail a loss in travel time.

Instead of the stationary charging process, there is the option of a dynamic charging process, wherein the vehicle can be inductively charged while driving. Several known processes and systems already exist in this technical field.

The article “A Review of Dynamic Wireless Power Transfer for In-Motion Electric Vehicles” (see https://www.intechopen.com/books/wireless-power-transfer-fundamentals-and-technologies/a-review-of-dynamic-wireless-power-transfer-for-in-motion-electric-vehicles) describes various developments in dynamic wireless power transfer (English: Dynamic Wireless Power Transfer—abbreviated DWPT).

However, there continue to be disadvantages to these developments which must be overcome or resolved. These disadvantages essentially relate to the fact that, in known solutions corresponding to prior art, the immovably fixed primary side is energized over a spatially larger area than required for the actual power transfer based on the overall length of the secondary part of the charging system connected with the transport device. The disadvantage here is that a magnetic field comes about even outside of the transfer range that can exert hazardous influences on living beings, that heat losses come about outside of the transfer range which impair transfer efficiency, and that the generation of magnetic fields requires that an additional reactive power be provided even outside of the transfer range. Another disadvantage to the solutions in prior art is that the geometric design of the magnetic field is defined solely by the geometry of the primary coil systems, and cannot be flexibly adjusted to varying requirements of different secondary systems.

Therefore, the object of the present invention is to enable dynamic charging, wherein an optimal power transfer is achieved between the primary side and secondary side. In addition, the demand for active and reactive power for the primary apparatus and power losses owing to the incomplete or incorrect alignment of the primary side and secondary side are to be minimized.

This object is achieved by a device for generating a magnetic field according to claim 1.

Provided here according to the invention is a device for generating a magnetic field for an inductive charging system, with at least one electrical conductor for generating the magnetic field, a supply unit for generating an alternating current for the at least one electrical conductor, and a detection unit for detecting a secondary charging system. This device is characterized by a communication unit for transmitting and receiving data to/from an identical device, wherein the device is designed to control the supply unit by means of the detection unit and/or by means of the received data, and hence the generation of the magnetic field for inductive power transfer.

The advantage to this device is that it can be self- and/or remote controlled, and thus already contribute while generating the magnetic field for power transfer, even if the secondary system was not yet detected by the device itself. Another advantage is the ability of the device, either by means of the detection unit and/or by means of the received data, to determine what properties the alternating current to be generated must have to generate a magnetic field determined by a possibly differing geometry established as required by the secondary system.

The communication unit is preferably designed to transmit and receive the data in a wireless and/or corded manner, and wherein the detection unit is designed to identify the secondary charging system, in particular its kind and type, and generate the mentioned data based on an identified secondary charging system. In addition to detection, having the device identify the secondary charging system is advantageous to determine the alternating current to be generated and/or generate data for other identical devices.

It has further proven advantageous that the device be designed to be supplied with a direct current, and wherein the supply unit, in particular with a half or full bridge circuit, is designed to convert the direct current into an alternating current. Given a direct current supply, no additional reactive power is required, and no additional losses arise, for example owing to eddy currents.

The detection unit is preferably designed to detect and/or identify a secondary charging system by measuring the impedance of the electrical conductor, and by measuring the voltage drop on the electrical conductor and/or a pilot signal received by the electrical conductor. Involved here are various concrete possible configurations, e.g., in the form of an electronic model simulation of the inductive transfer system and the detection of changes in this model by the secondary system for detecting and identifying the secondary charging system.

Alternatively or additionally to the electrical conductor as the receiver, the detection unit can have another receiving means, in particular in the form of a detection coil, so as to detect and/or identify a secondary charging system. The receiving means can separately receive the signal from a secondary charging system, thereby improving the detection and/or identification.

In addition, the object mentioned above is achieved by a primary apparatus for the contactless, inductive power transfer to transport means according to claim 6.

The invention here provides a primary apparatus of an inductive charging system for the contactless, inductive power transfer to transport means, wherein the primary apparatus can be arranged at a road surface level. The apparatus has a plurality of devices for generating a magnetic field, the device in particular according to one of claims 1 to 5, and is characterized in that the devices are communicatively interconnected and have a plurality of electrical conductors for generating a magnetic field. In addition, the arrangement and actuation of electrical conductors of the devices are designed in such a way that a magnetic field can be generated by a portion of the electrical conductors, and this magnetic field can be displaced by correspondingly actuating the electrical conductors with a static motion, in particular in increments smaller than the expansion of the generatable magnetic field.

One advantage to the primary apparatus according to the invention is that a magnetic field can be generated and moved with quasi infinitesimally small increments; depending on the arrangement and/or configuration of the electrical conductors (e.g., the distance between the conductors) as well as their actuation with an alternating current. This makes it possible to align the magnetic field to a specific secondary-side charging system.

Another advantage lies in the fact that only a portion of the primary apparatus requires power for generating the magnetic field, so that it can be operated in an energy efficient manner, and that the required reactive power demand can be kept low. To this end, only a percentage of the devices supply alternating current to the corresponding electrical conductors, so as to generate the magnetic field. The remaining devices are inactive, and only activated once the magnetic field has been moved to their position.

The primary apparatus likewise has the advantage of exhibiting a high failure redundancy. Even if one or several of the devices for generating a magnetic field should fail, the primary apparatus can continue to be operated, and a correspondingly adjusted magnetic field can be generated for power transfer.

Another advantage to the primary apparatus is its capacity to generate various magnetic fields both simultaneously, with varying shapes, strengths, and types, adjusted to the requirements of varying secondary systems. For example, the types include circular and transversal geometries of the magnetic fields. As a result, the primary apparatus can be used by different types of secondary charging systems, for example with circular coils or double coils (suitable for magnetic fields with a transversal geometry).

The electrical conductors are preferably actuated depending on the position, speed, shape, and type of the secondary charging system detected by at least one device. This has the advantage of positioning or aligning the generated magnetic field to the secondary charging position, and accompanying it while the vehicle is moving. The type of the generated magnetic field can likewise be set so as to optimize the power transfer.

It has proven particularly advantageous to arrange the electrical conductors parallel to each other and transverse to the traveling direction of the road surface level. This arrangement and formation of conductors is easy to produce, inexpensive and effective in generating the magnetic field.

With flexible magnetic field generation as the objective, the actuation of electrical conductors is designed in such a way that a portion of the electrical conductors is actuated according to a specific pattern, with a specific alternating current and in chronologically determined increments. The alternating current itself can vary in terms of its frequency, phase and/or amplitude, wherein the individual electrical conductors can be supplied with respectively varying alternating currents. As a consequence, various magnetic fields with different shapes can be generated, and be moved or displaced in various directions at various speeds.

The electrical conductors preferably consist of strands, solid conductors, or tubes. Owing to their configuration, these conductors have various properties, and hence possible applications with respect to the road surface level and environmental influences, such as ambient temperature.

Another advantage is when the reactance of the electrical conductors is compensated by capacitors integrated into the conductors or the devices and/or by the arrangement of electrical conductors and the resultant impedances. In this way, the conductor forms a resonance, and requires less reactive power when supplying alternating current.

In order to bundle the magnetic field and allow the alternating current of the electrical conductors to return to the device, the primary apparatus preferably has at least one electrically conductive element arranged below the conductors, for example in the form of a sheet or an electrical connection to the switching unit. In addition, the magnetic field can be bundled or shielded using magnetically conductive material, for example in the form of soft ferrite strips or plates, which are arranged below the primary conductor.

With respect to the arrangement of primary conductors, let it be noted that a longitudinally aligned and/or mixed-aligned arrangement is also possible aside from the transversely aligned one. In like manner, the primary conductors can be straight or arced and/or have a combination of both designs. The primary conductors can be arranged on one or several different levels.

With respect to the actuation of primary conductors, let it be noted that there can also be actuation processes other than incremental actuation, in which the next primary conductor in one direction of movement is always supplied with an alternating current. For example, each second, third or n-th primary conductor could be actuated. It is likewise possible for one or several primary conductors to be simultaneously deactivated and/or for one or several primary conductors to be simultaneously added or activated for moving the magnetic field. This makes it possible to adjust the transfer performance to the transfer demand. In addition, the primary conductors can be actuated according to a specific pattern.

The device for generating a magnetic field can be connected with one or several primary conductors, wherein the primary conductors can be supplied with a separate alternating current, whether individually or together, in particular simultaneously.

In addition, the invention relates to a method for generating a magnetic field comprising the following steps:
a) Generating at least one alternating current;
b) Supplying a first quantity of electrical conductors with the at least one alternating current in order to generate a magnetic field;
c) Supplying a second quantity of electrical conductors with the at least one alternating current in order to move or displace the magnetic field, wherein the electrical conductors of the second quantity are identical with at least a portion of the electrical conductors of the first quantity and/or lie or are arranged in their space and/or surface covered by the electrical conductors of the first quantity.

In step c), the electrical conductors of the first quantity are no longer supplied with the alternating current, provided these are not a portion of the second quantity.

This method is used in particular in conjunction with the primary apparatus according to the invention.

The following description relates to preferred exemplary embodiments according to the present invention, which are not to be considered as a limitation, but merely as part of the instruction. Let it be emphasized that a combination of features described herein is easily possible, and explicitly part of the disclosure of the present invention.

Shown on:

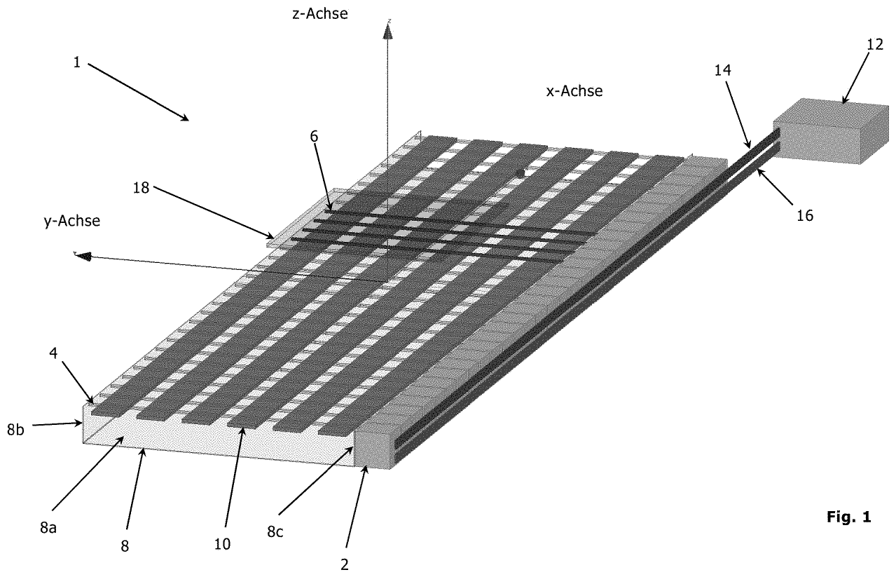

FIG. 1 is a perspective view in particular of a primary apparatus of an inductive charging system, the primary apparatus as an exemplary embodiment according to the invention;

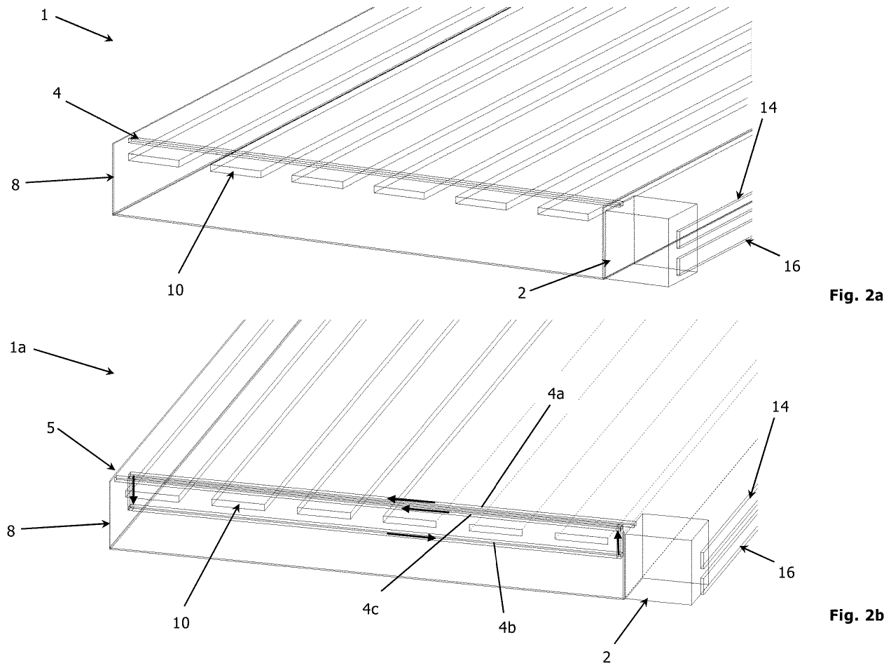

FIG. 2a is another perspective view of the primary apparatus on FIG. 1;

FIG. 2b is a perspective view of a primary apparatus based on another exemplary embodiment according to the invention;

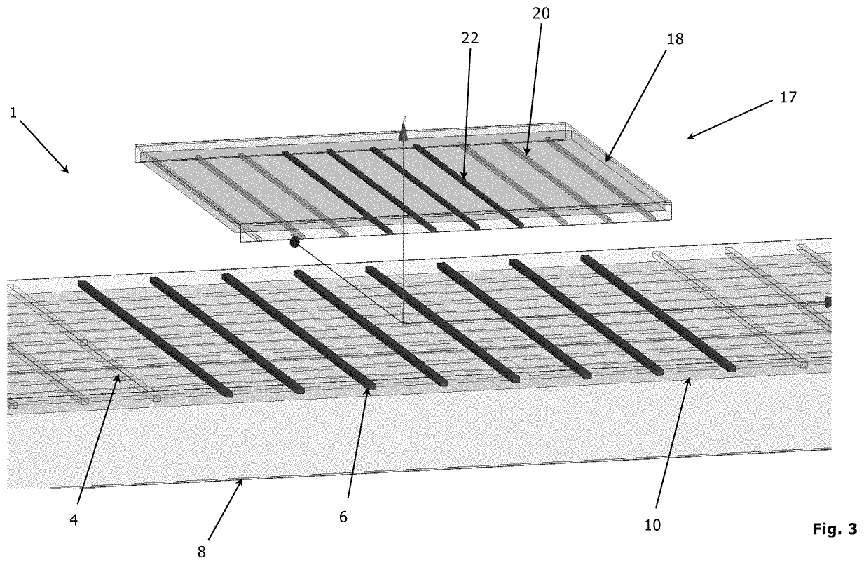

FIG. 3 is another perspective view of the primary apparatus on FIG. 1 with a secondary charging system;

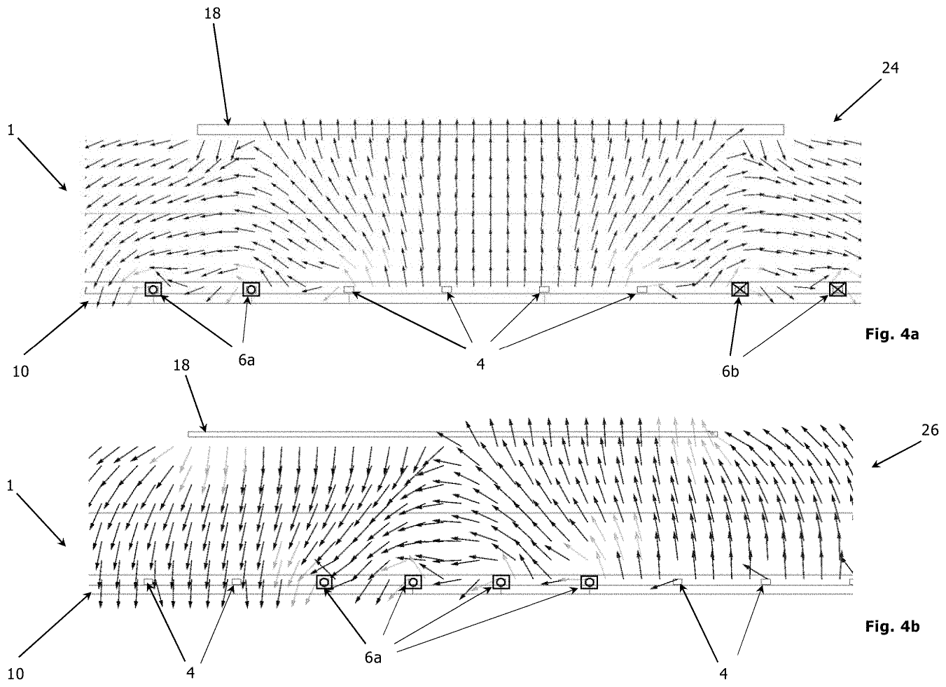

FIG. 4a is a side view of the primary apparatus on FIG. 3, which is operated in the circular mode;

FIG. 4b is a side view of the primary apparatus on FIG. 3, which is operated in the transversal mode;

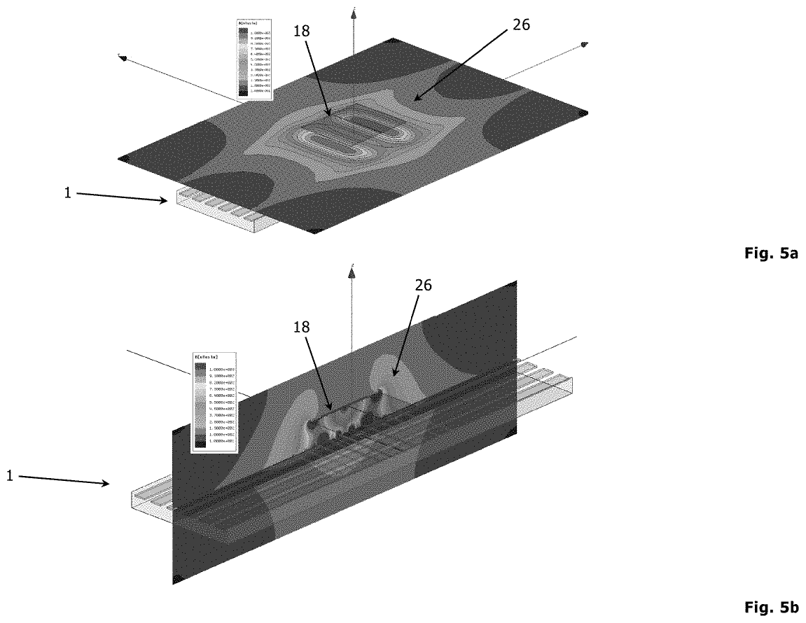

FIG. 5a is a perspective view of a primary apparatus according to the invention operated in the transversal mode, wherein the magnetic field density is indicated on a level parallel to and above the primary apparatus;

FIG. 5b is a perspective view of a primary apparatus according to the invention operated in the transversal mode, wherein the magnetic field density is indicated on a level perpendicular to and along the road surface level to the primary apparatus;

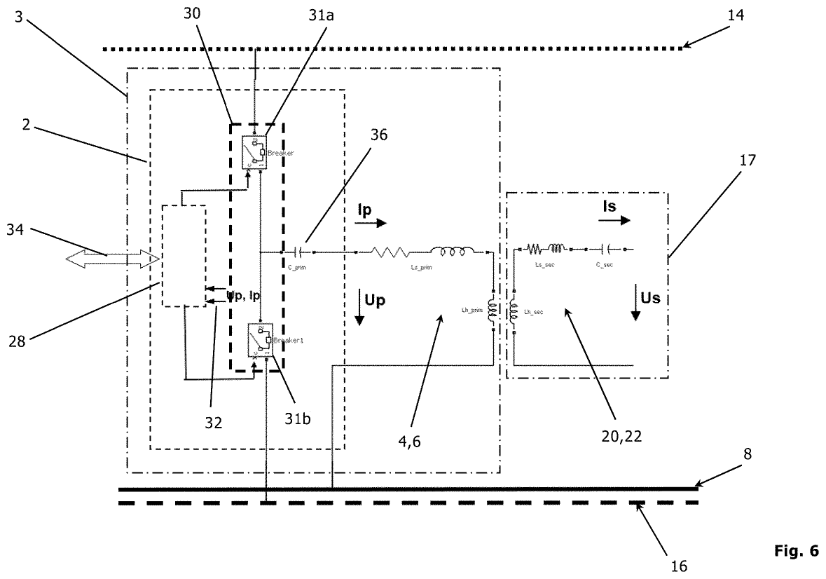

FIG. 6 is a circuit diagram of a device for supplying an electrical conductor for generating a magnetic field, the device as part of a primary apparatus according to the invention;

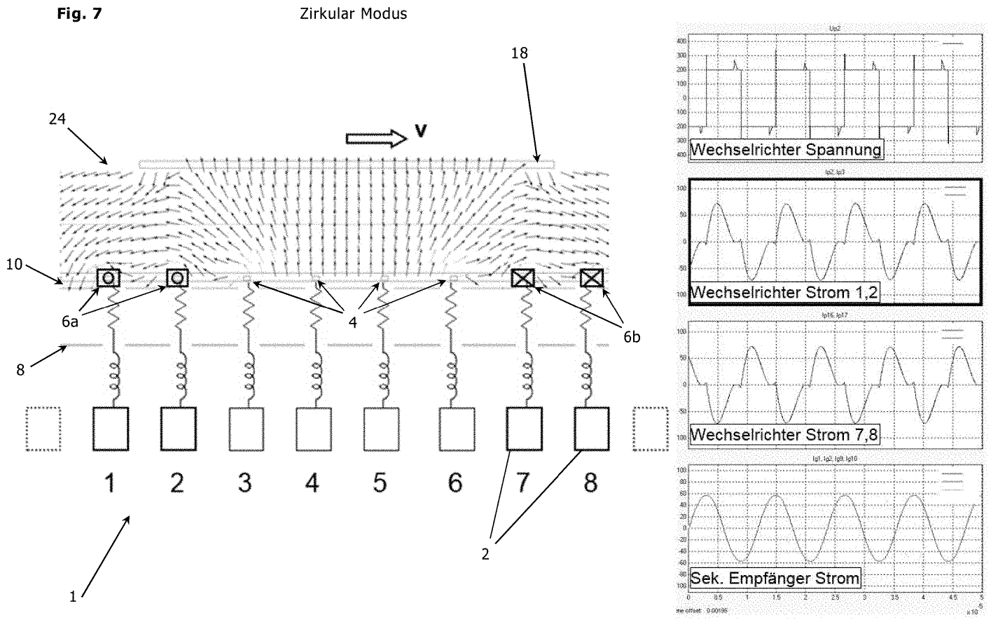

FIG. 7 is a side view of the primary apparatus operated in the circular mode on FIG. 3, the switching units hooked up to the primary conductors, as well as the voltage/current diagrams for the switching units, primary and secondary conductors;

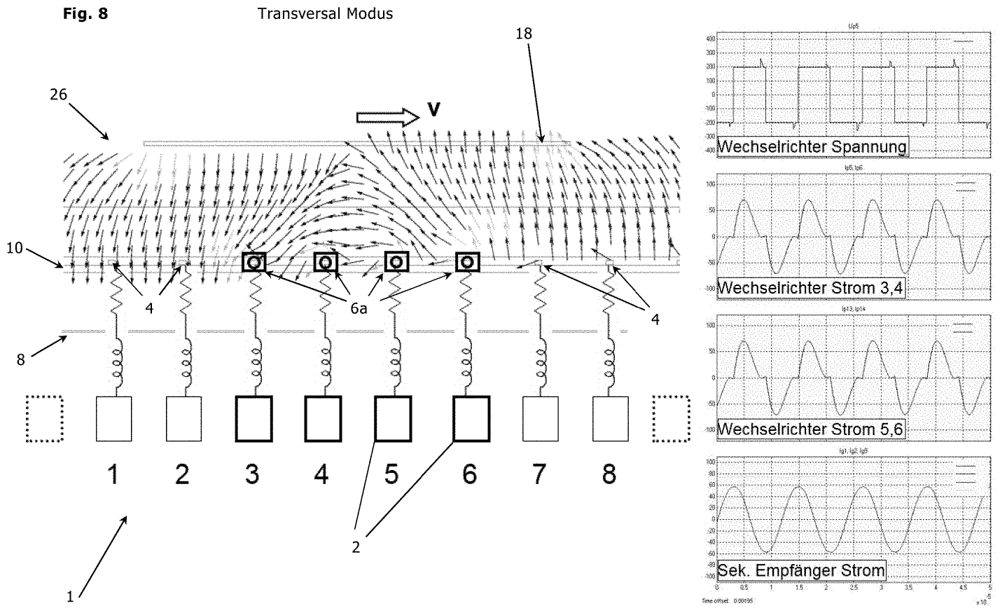

FIG. 8 is a side view of the primary apparatus operated in the transversal mode on FIG. 3, the switching units hooked up to the primary conductors, as well as the voltage/current diagrams for the switching units, primary and secondary conductors; and

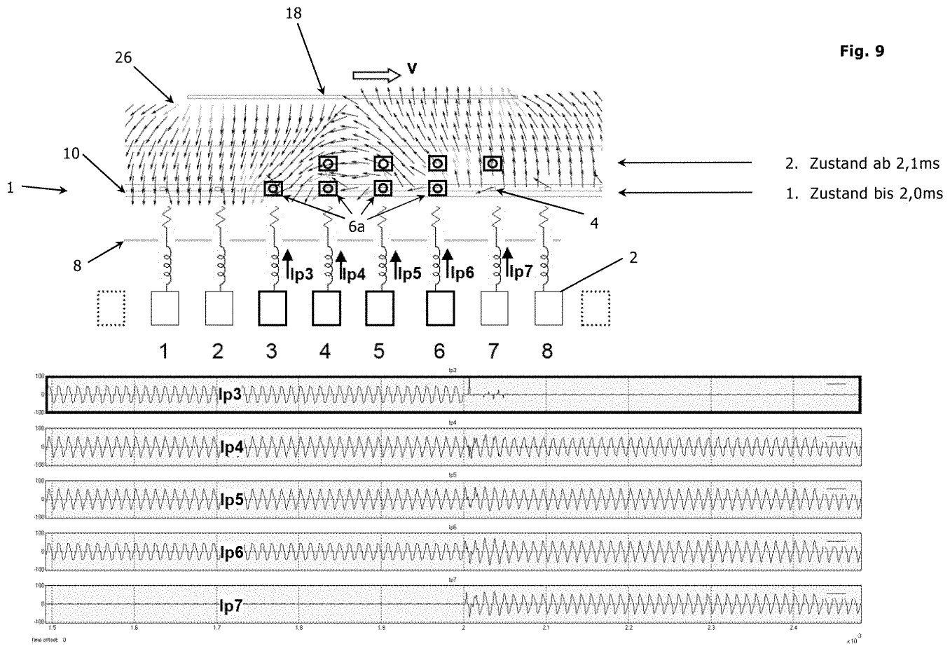

FIG. 9 is another side view of the primary apparatus operated in the transversal mode on FIG. 3, the switching units hooked up to the primary conductors (in two different states), as well as the current diagrams for the switching units or primary conductors.

FIG. 1 shows a perspective view of a primary apparatus 1 as an exemplary embodiment according to the invention. The primary apparatus 1 has a plurality of electronic switching units 2, which are arranged along the X-axis (the traveling direction) and communicatively interconnected for purposes of data exchange. Data exchange can take place corded or wirelessly, e.g., via radio. Each switching unit 2 is electrically connected with a primary conductor 4, 6, which extend parallel to each other and from the respective switching unit 2 along the Y-axis. The primary conductors 4, 6 can be designed as a strand (English stranded wire), solid conductor and/or tube. In addition, all primary conductors 4, 6 have the same length and the same distance relative to their adjacent primary conductors. On the figure, four primary conductors 6 arranged one next to the other are active, i.e., an alternating current flows through the latter and a magnetic field is generated, while the remaining primary conductors 4 are inactive. Ferrite strips 10 below the primary conductors 4, 6 are arranged parallel to each other and along the X-axis or transverse to the primary conductors 4, 6. Among other things, the ferrite strips 10 are used [among other things] for bundling the magnetic flow of the current carrying conductors in a low-loss manner, conducting it, and/or increasing its inductance. An electrically conductive sheet 8 is arranged below the ferrite strips 10 as a ground and/or feedback conductor. The sheet 8 is tub- or trough-shaped in design, i.e., in this example it has a rectangular, planar floor sheet 8a aligned along the X-axis and two side sheets 8b, 8c arranged on both sides of the floor sheet and perpendicular thereto. The width of the sheet 8, in particular of the floor sheet 8a, corresponds to the length of the primary conductor 4, 6. The respective ends of all primary conductors 4, 6 are electrically connected with the sheet 8 at the upper edge of the left side sheet 8b. While the primary conductors 4, 6, the ferrite strips 10 and the sheet 8 are arranged on the one side of the switching units 2, two DC busbars 14 and 16 are arranged on the opposing side of the switching units 2, and connected with each switching unit 2. The upper DC busbar 14 has an exemplary voltage of +200V, and the lower DC busbar 16 has an exemplary voltage of −200V. Both busbars 14, 16 are electrically powered via a direct current source 12, and extend parallel to each other and on a straight line along the X-axis. In addition, FIG. 1 shows a ferrite plate 18 of a secondary charging system or receiving system (not depicted). Similarly to the ferrite strips 10, this plate is used to bundle the magnetic field or the magnetic flow for the secondary charging system. Arranged below the ferrite plate 18 are the active primary conductors 6, which are activated depending on the position relative to the ferrite plate 10 and/or to the secondary charging system, so as to enable an inductive charging process from the primary side to the secondary side. The primary apparatus 1 is designed to transfer preferably 20 kW of power, wherein the alternating current supplied to the primary conductors 4, 6 can have a frequency of 85 kHz and a current amplitude of +/−70 amperes. The primary conductors 6, 7 can have a distance of between 50 and 100 mm, and a length of 1 m. The surface of the ferrite plate preferably measures 500×600 mm. FIGS. 2a and 2b each show a perspective view of two different primary apparatuses 1 and 1a, wherein the first apparatus 1 (on FIG. 2a) originates from FIG. 1. The second apparatus 1a (on FIG. 2b) comprises an additional exemplary embodiment according to the invention. It essentially corresponds to the first system 1, but differs significantly in terms of the configuration of primary conductors 4. Instead of straight primary conductors, the second system 1a is equipped with conductor loops 5, which each are electrically connected with a switching unit 2 at one end and with the sheet 8 at the other end. In the example shown, the conductor loop 5 essentially has three straight lines, of which the two feeder lines 4a and 4c are arranged above the ferrite strips 10, and the return line 4b is arranged below the ferrite strips 10. All three lines 4a, 4b, 4c run transverse to the ferrite strips 10. The advantage to the conductor loop 5 is that it can generate a stronger magnetic field above the ferrite strips 10 due to the double feeder lines 4a and 4c.

FIG. 3 shows an additional perspective view of the primary apparatus on FIG. 1, wherein the ferrite plate 18 of the secondary charging system 17 is depicted in more detail. Ten secondary conductors 20, 22 are exemplarily arranged parallel to each other below the secondary ferrite plate 18. Of those, the four secondary conductors 22 arranged in the middle are active in the transversal mode, and thus ready to receive the magnetic field sent out by the primary apparatus 1 and to transfer power. The remaining six secondary conductors 20 are currently inactive, and not ready for power transfer at the moment, but could be activated for considering the circular mode. Eight adjacent primary conductors 6 are controlled in the primary apparatus 1, and are thus active as a function of the operation in the transversal or circular mode.

FIGS. 4a and 4b each show a magnetic field emitted or generated by the primary conductors 6a and/or 6b of the primary apparatus 1. The first magnetic field 24 shown on FIG. 4a was formed in the so-called circular mode, and the second magnetic field 26 shown on FIG. 4b in the so-called transversal mode. The ferrite plate 18 is arranged above the respective magnetic fields 24, 26, and bundles the respective magnetic flow. The ferrite strips 10 described above are arranged below the primary conductors 6a, 6b. In order to generate the first magnetic field 24, the two primary conductors 6a arranged on the left are active, the ensuing four primary conductors 4 are inactive, and the two primary conductors 6b arranged on the right are active. A current flows out of the drawing plane for the left active primary conductors 6a, and a current flows into the drawing plane for the right active primary conductors 6b. In order to generate the second magnetic field 26, the two primary conductors 4 arranged on the left are inactive, the ensuing four primary conductors 6a are active, and the two primary conductors 4 arranged on the right are inactive. A current here flows out of the drawing plane for the active primary conductors 6a. Let it be noted that the active primary conductors 6a, 6b are supplied with an alternating current. The figures hence show snapshots of when the alternating current has a specific phase and amplitude. After half an oscillation period, the current directions in the primary conductors point in the opposite direction, and the magnetic field 24, 26 has also turned around.

FIG. 5a shows a perspective view of a primary apparatus 1 according to the invention operated in the transversal mode, wherein the density of the magnetic field 26 is indicated on a level parallel to and above the primary apparatus. Also arranged is the ferrite plate 18, which influences the magnetic field 26 accordingly. The magnetic field 26 is characterized by two parallel arranged, longitudinally extending magnetic field centers.

FIG. 5b shows a perspective view of a primary apparatus 1 according to the invention operated in the transversal mode, wherein the density of the magnetic field 26 is indicated on a level perpendicular to and along the road surface level to the primary apparatus. Also arranged is the ferrite plate 18, which as readily evident, influences the magnetic field 26 accordingly or limits its expansion up to the plate 18.

FIG. 6 shows a circuit diagram of a device 3 for supplying an electrical conductor 4, 6 with an alternating current for generating a magnetic field, the device 3 as part of a primary apparatus 1, 1a according to the invention. The device 3 comprises the switching unit 2, the primary conductor 4, 6, and optionally at least in part the ground bar 8, which were all already described on FIG. 1. The switching unit 2 is connected with the DC busbars 14 and 16, and is exemplarily supplied by the latter with a DC voltage of +/−200V. In detail, the switching unit 2 has a control circuit 28 with integrated communication unit and detection unit, a supply unit or inverter 30, and a compensation capacitor 36 for the primary conductor 4, 6. The supply unit 30 has two controlled switches 31a and 31b, which each are electrically connected with a DC busbar 14, 16. The two switches 31a, 31b are controlled by the control circuit 28, and alternatingly switch a DC voltage with a positive voltage and a DC voltage with a negative voltage from the busbars 14, 16 to the active primary conductor 6. If the primary conductor is inactive, both switches 31a, 31b are open, and no current flows into the primary conductor 4. The control circuit 28 is further designed in such a way that a wireless and/or corded communication connection 35 can be built up with another electronic device, in particular with an adjacently arranged switching unit 2. The control circuit 28 is likewise configured in such a way that the current flow Ip and supply voltage Up of the primary conductor 4, 6 can be measured via a measuring (signal) input 32. The compensation capacitor 36 compensates for the stray induction of the primary conductor 4, 6, and allows the primary conductor 4, 6 to be operated in resonance. Shown on the side of the secondary charging system 17 is the secondary conductor 20, 22, which has been/is magnetically coupled with the primary conductor 4, 6 by means of a magnetic field (e.g., in the circular mode or transversal mode). A voltage is hereby induced, which is used to charge the vehicle containing the secondary charging system 17.

FIG. 7 shows a side view of the primary apparatus 1 operated in the circular mode on FIG. 3, the switching units 2 hooked up to the primary conductors 6a, 6b, as well as the voltage/current diagrams for the switching units, primary and secondary conductors. The arrangement and current circuitry of the active primary conductors 6a and 6b for generating the magnetic field 24 were already discussed on FIG. 4a. As also shown, each primary conductor 4, 6a, 6b is electrically connected with a separate switching unit 2 (numbered 1 to 8). The four signal diagrams arranged on the right show the voltage of the inverter, the current of the inverters numbered 1 and 2, the current of the inverters numbered 7 and 8, and the current received on the secondary side. The current of the inverters 1 and 2 and the current of the inverters 7 and 8 are identical in amplitude and frequency, but have a mutual phase shift of 180 degrees or 7C in the operating mode depicted.

FIG. 8 shows a side view of the primary apparatus 1 operated in the transversal mode on FIG. 3, the switching units 2 hooked up to the primary conductors 6a, as well as the voltage/current diagrams for the switching units, primary and secondary conductors. The arrangement and current circuitry of the active primary conductors 6a for generating the magnetic field 24 were already discussed on FIG. 4b. As also shown, each primary conductor 4, 6a is electrically connected with a separate switching unit 2 (numbered 1 to 8). The four signal diagrams arranged on the right show the voltage of the inverter or supply units, the current of the inverters or supply units numbered 3 and 4, the current of the inverters or supply units numbered 5 and 6, and the current received on the secondary side. The current of the inverters 3 and 4 and the current of the inverters 5 and 6 are identical, in particular in terms of phase, amplitude and frequency.

FIG. 9 shows another side view of the primary apparatus 1 operated in the transversal mode on FIG. 3, the switching units 2 hooked up to the primary conductors 4 and 6a (in two different states, 1^{st} and 2^{nd}), as well as the current diagrams Ip3 to Ip7 of the switching units 2 numbered 3 to 7 or the primary conductors. The alternating currents shown in the current diagrams are identical in phase, amplitude, and frequency, and were depicted over a time of 1.5 ms to 2.5 ms. In the time up to 2.0 ms (1^{st} state), the switching units 2 numbered 3 to 6 generate the currents Ip3 to Ip6, and hence the depicted magnetic field 26 via the primary conductors. Starting at 2.0 ms, the inverter of switching unit number 7 starts to supply the primary conductor 4 with the same alternating current. At the same time, the inverter of switching unit number 3 is deactivated, wherein the alternating current Ip3 decays to zero amperes after a short time (approx. 0.5 ms decay time). The time between 2.0 ms and 2.1 ms is regarded as a transition period, in which the current Ip3 rises and the current Ip7 decays. Starting at 2.1 ms (2^{nd} state), the switching units numbered 4 to 7 and the corresponding primary conductors 6a are now active, and the magnetic field 26 has shifted by an increment. These steps can always be continued from one switching unit to the next adjacent switching unit. The same holds true for the arrangement and wiring of the primary conductor for a magnetic field in the circular mode.

### REFERENCE LIST

1 Charging system, primary part/primary apparatus
1a Charging system, primary part/primary apparatus (as an additional exemplary embodiment)
2 Electronic switching unit
3 Device for generating a magnetic field
4 Electrical primary conductor—inactive
4a First feeder line (of the conductor loop)
4b Return line (of the conductor loop)
4c Second feeder line (of the conductor loop)
5 Conductor loop
6 Primary electrical conductor—active
6a Primary electrical conductor (current flows out of the drawing plane)
6b Primary electrical conductor (current flows into the drawing plane)
8 Electrically conductive sheet/ground/ground bar
8a Floor sheet
8b Side sheet
8c Side sheet
10 Ferrite strip
12 Direct current source
14 Positive DC busbar
16 Negative DC busbar
17 Charging system, secondary part/secondary apparatus
18 Ferrite plate (of the secondary part of the charging system or the secondary coil)
20 Secondary electrical conductor—inactive
22 Secondary electrical conductor—active
24 Magnetic field—circular mode
26 Magnetic field—transversal mode
28 Control circuit (with communication and detection unit)
30 Supply unit (inverter)
31a First controlled switch
31b Second controlled switch
32 Measuring signal input
34 Communication connection
36 Compensation capacitor (for primary conductor)

1. A device for generating a magnetic field for an inductive charging system, with
at least one electrical conductor for generating the magnetic field,
a feeder unit for generating an alternating current for the at least one electrical conductor, and
a detection unit for detecting a secondary charging system,
wherein
a communications unit for transmitting and receiving data to/from an identical device,
wherein the device is set up to control the supply unit by means of the detection unit and/or by means of the received data, and hence the generation of the magnetic field for inductive power transfer.

2. The device according to claim 1,
wherein
the communication unit is designed to transmit and receive the data in a wireless and/or corded manner, and wherein detection unit is designed to identify the secondary charging system, in particular its kind and type, and generate the mentioned data based on an identified secondary charging system.

3. The device according to claim 1,
wherein
the device is designed to be supplied with a direct current, and wherein the supply unit, in particular with a half or full bridge circuit, is designed to convert the direct current into an alternating current.

4. The device according to claim 1,
wherein
the detection unit is designed to detect and/or identify a secondary charging system by measuring the impedance of the electrical conductor, and by measuring the voltage drop on the electrical conductor and/or a pilot signal received by the electrical conductor.

5. The device according to claim 1,
wherein
the detection unit has a receiving means, in particular in the form of a detection coil, so as to detect and/or identify a secondary charging system.

6. A primary apparatus of an inductive charging system for the contactless, inductive power transfer to transport means, wherein the primary apparatus can be arranged at a road surface level,
with
a plurality of devices for generating a magnetic field, the device in particular according to claim 1,
wherein
the devices are communicatively interconnected and have a plurality of electrical conductors for generating a magnetic field,
wherein the arrangement and actuation of the electrical conductors are designed in such a way that a magnetic field can be generated by a least a portion of the electrical conductors, and this magnetic field can be displaced by correspondingly actuating the electrical conductors with a static motion in increments smaller than the expansion of the generatable magnetic field.

7. The primary apparatus according to claim 6,
wherein
the electrical conductors are actuated depending on the position, speed, shape, and type of the secondary charging system detected by at least one device.

8. The primary apparatus according to claim 6,
wherein
the electrical conductors are arranged parallel to each other and transverse to the traveling direction of the road surface level.

9. The primary apparatus according to claim 6,
wherein
the actuation actuation of electrical conductors is designed in such a way that the electrical conductors are actuated according to a specific pattern, with a specific alternating current and in chronologically determined increments.

10. The primary apparatus according to claim 6,
wherein
the electrical conductors consist of strands, solid conductors, or tubes.

11. The primary apparatus according to claim 6,
the reactance of the electrical conductors is compensated for by capacitors integrated into the conductors or the devices and/or by the arrangement of electrical conductors and the resultant impedances.

12. The primary apparatus according to claim 6,
wherein
the alternating current of the electrical conductors is returned to the device via at least one electrically conductive element arranged below the conductors, in particular in the form of a sheet, a grid and/or a bar.

13. A method for generating a magnetic field, in particular in conjunction with a primary apparatus according to claim 6, wherein the method comprises the following steps:
Generating at least one alternating current;
Supplying a first quantity of electrical conductors with the at least one alternating current in order to generate a magnetic field;
Supplying a second quantity of electrical conductors with the at least one alternating current in order to move or displace the magnetic field, wherein the electrical conductors of the second quantity are identical with at least a portion of the electrical conductors of the first quantity or lie or are arranged in their space and/or surface covered by the electrical conductors of the first quantity.
